(19) United States
(12) Patent Application Publication
(10) Pub. No.: US 2008/0170293 A1
(43) Pub. Date: Jul. 17, 2008

(54) Dynamic autostereoscopic displays

(76) Inventors: Mark E. Lucente, Austin, TX (US); Michael A. Klug, Austin, TX (US); Anthony W. Heath, Austin, TX (US); Tizhi Huang, Plano, TX (US); Mark E. Holzbach, Austin, TX (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 11/724,832

(22) Filed: Mar. 15, 2007

Related U.S. Application Data
(60) Provisional application No. 60/782,345, filed on Mar. 15, 2006.

(51) Int. Cl. G02B 27/22

(52) U.S. Cl. 359/463

(57) ABSTRACT

It has been discovered that emissive display devices can be used to provide display functionality in dynamic autostereoscopic displays. One or more emissive display devices are coupled to one or more appropriate computing devices. These computing devices control delivery of autostereoscopic image data to the emissive display devices. A lens array coupled to the emissive display devices, e.g., directly or through some light delivery device, provides appropriate conditioning of the autostereoscopic image data so that users can view dynamic autostereoscopic images.

The U.S. Government has a paid-up license in this invention and the right in limited circumstances to require the patent owner to license others on reasonable terms as provided for by the terms of contract No. NBCHC050098 awarded by DARPA. This application claims the benefit, under 35 U.S.C. § 119 (e), of U. S. Provisional Application No. 60/782,345, filed Mar. 15, 2006, entitled “Active Autostereoscopic Emissive Displays,” and naming Mark Lucente, et. al, as inventors. The above-referenced application is hereby incorporated by reference herein in its entirety.

### BACKGROUND

1. Field of the Invention

The present invention relates in general to the field of autostereoscopic displays, more particularly, to dynamically updateable autostereoscopic displays.

2. Description of the Related Art

A graphical display can be termed autostereoscopic when the work of stereo separation is done by the display so that the observer need not wear special eyewear. A number of displays have been developed to present a different image to each eye, so long as the observer remains fixed at a location in space. Most of these are variations on the parallax barrier method, in which a fine vertical grating or lenticular lens array is placed in front of a display screen. If the observer's eyes remain at a fixed location in space, one eye can see only a certain set of pixels through the grating or lens array, while the other eye sees only the remaining set.

One-step hologram (including holographic stereogram) production technology has been used to satisfactorily record holograms in holographic recording materials without the traditional step of creating preliminary holograms. Both computer image holograms and non-computer image holograms can be produced by such one-step technology. In some one-step systems, computer processed images of objects or computer models of objects allow the respective system to build a hologram from a number of contiguous, small, elemental pieces known as elemental holograms or hogels. To record each hogel on holographic recording material, an object beam is typically directed through or reflected from a spatial light modulator (SLM) displaying a rendered image and then interfered with a reference beam. Examples of techniques for one-step hologram production can be found in U.S. Pat. No. 6,330,088 entitled “Method and Apparatus for Recording One-Step, Full-Color, Full-Parallax, Holographic Stereograms,” naming Michael A. Klug, Mark E. Holzbach, and Alejandro J. Ferdman as inventors, (“the '088 patent”) which is hereby incorporated by reference herein in its entirety.

Many prior art autostereoscopic displays, such as many holographic stereogram displays, are static in nature. That is, the image volumes displayed cannot be dynamically updated. Existing autostereoscopic displays that are in some sense dynamic, rely on parallax barrier methods and/or back-lit transmissive spatial light modulator (SLM) displays. These devices suffer from various disadvantages including limited usability by multiple users, poor image quality due to transmissive SLMs, fringe field effects, and the like.

Accordingly, it is desirable to have improved systems and methods for producing, displaying, and interacting with dynamic autostereoscopic displays to overcome the above-identified deficiencies in the prior art.

### SUMMARY

It has been discovered that emissive display devices can be used to provide display functionality in dynamic autostereoscopic displays. One or more emissive display devices are coupled to one or more appropriate computing devices. These computing devices control delivery of autostereoscopic image data to the emissive display devices. A lens array coupled to the emissive display devices, e.g., directly or through some light delivery device, provides appropriate conditioning of the autostereoscopic image data so that users can view dynamic autostereoscopic images.

### BRIEF DESCRIPTION OF THE DRAWINGS

The subject matter of the present application may be better understood, and the numerous objects, features, and advantages made apparent to those skilled in the art by referencing the accompanying drawings.

FIG. 1 is a block diagram of a dynamic autostereoscopic display system.

FIG. 2 illustrates an example of a dynamic autostereoscopic display module.

FIG. 3 illustrates an example of an optical fiber taper that can be used in dynamic autostereoscopic display modules.

FIGS. 4A-4C illustrate an example of a bundled optical fiber system that can be used in dynamic autostereoscopic display modules.

FIGS. 5A-5B illustrate another example of a bundled optical fiber system that can be used in dynamic autostereoscopic display modules.

FIG. 6 illustrates an example of a multiple element lenslet system that can be used in dynamic autostereoscopic display modules.

FIG. 7 illustrates an example of a dynamic autostereoscopic display module where optical fiber tapers or bundles are not used.

FIGS. 8A-8C illustrate the use of optical diffusers in dynamic autostereoscopic display modules.

FIG. 9 illustrates still another use of optical diffusers in dynamic autostereoscopic display modules.

### DETAILED DESCRIPTION

The following sets forth a detailed description of the best contemplated mode for carrying out the invention. The description is intended to be illustrative of the invention and should not be taken to be limiting.

The present application discloses various embodiments of and techniques for using and implementing active or dynamic autostereoscopic emissive displays. Full-parallax three-dimensional emissive electronic displays (and alternately horizontal parallax only displays) are formed by combining high resolution two-dimensional emissive image sources with appropriate optics. One or more computer processing units may be used to provide computer graphics image data to the high resolution two-dimensional image sources. In general, numerous different types of emissive displays can be used. Emissive displays generally refer to a broad category of display technologies which generate their own light, including: electroluminescent displays, field emission displays, plasma displays, vacuum fluorescent displays, carbon-nanotube displays, and polymeric displays. In contrast, non-emissive displays require a separate, external source of light (such as the backlight of a liquid crystal display).

The hogels (variously “active” or “dynamic” hogels) described in the present application are not like one-step hologram hogels in that they are not fringe patterns recorded in a holographic recording material. Instead, the active hogels of the present application display suitably processed images (or portions of images) such that when they are combined they present a composite autostereoscopic image to a viewer. Consequently, various techniques disclosed in the '088 patent for generating hogel data are applicable to the present application. Other hogel data and computer graphics rendering techniques can be used with the systems and methods of the present application, including image-based rendering techniques. The application of those rendering techniques to the field of holography and autostereoscopic displays is described, for example, in U.S. Pat. No. 6,868,177, which is hereby incorporated by reference herein in its entirety. Numerous other techniques for generating the source images will be well known to those skilled in the art

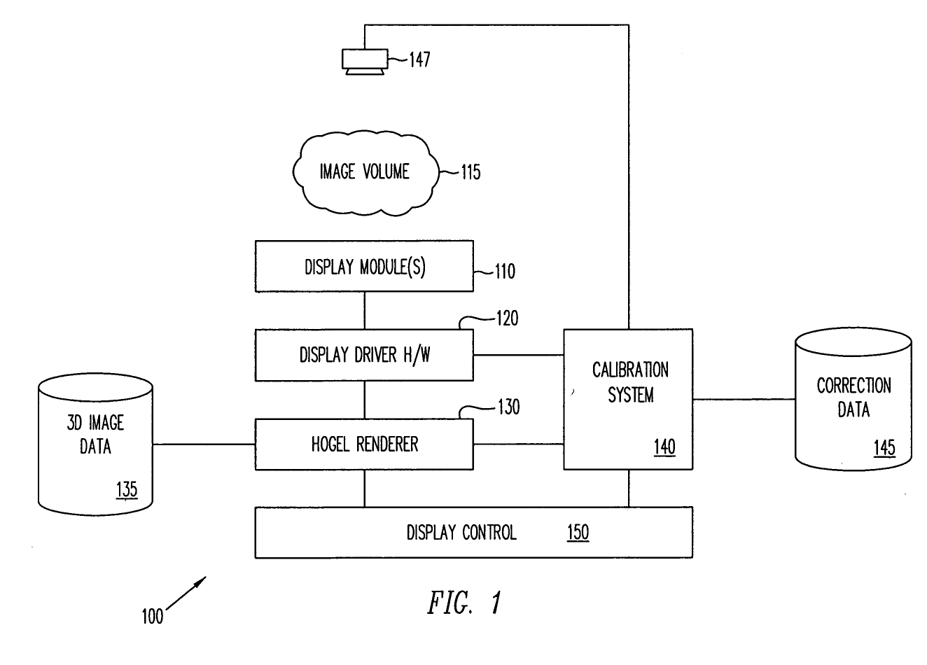

FIG. 1 illustrates a block diagram of an example of a dynamic autostereoscopic display system 100. Various system components are described in greater detail below, and numerous variations on this system design (including additional elements, excluding certain illustrated elements, etc.) are contemplated. At the heart of dynamic autostereoscopic display system 100 is one or more dynamic autostereoscopic display modules 110 producing dynamic autostereoscopic images illustrated by display volume 115. These modules use emissive light modulators or displays to present hogel images to users of the device. In general, numerous different types of emissive displays can be used. Emissive displays generally refer to a broad category of display technologies which generate their own light, including: electroluminescent displays, field emission displays, plasma displays, vacuum fluorescent displays, carbon-nanotube displays, and polymeric displays such as organic light emitting diode (OLED) displays. In contrast, non-emissive displays require a separate, external source of light (such as the backlight of a liquid crystal display). Dynamic autostereoscopic display modules 110 typically include other optical and structural components described in greater detail below.

Each of the emissive display devices employed in dynamic autostereoscopic display modules 110 is driven by one or more display drivers 120. Display driver hardware 120 can include specialized graphics processing hardware such as a graphics processing unit (GPU), frame buffers, high speed memory, and hardware provide requisite signals (e.g., VESA-compliant analog RGB, signals, NTSC signals, PAL signals, and other display signal formats) to the emissive display. Display driver hardware 120 provides suitably rapid display refresh, thereby allowing the overall display to be dynamic. Display driver hardware 120 may execute various types of software, including specialized display drivers, as appropriate.

Hogel renderer 130 generates hogels for display on display module 110 using 3D image data 135. Depending on the complexity of the source data, the particular display modules, the desired level of dynamic display, and the level of interaction with the display, various different hogel rendering techniques can be used. Hogels can be rendered in real-time (or near-real-time), pre-rendered for later display, or some combination of the two. For example, certain display modules in the overall system or portions of the overall display volume can utilize real-time hogel rendering (providing maximum display updateability), while other display modules or portions of the image volume use pre-rendered hogels.

Distortion associated with the generation of hogels for horizontal-parallax-only (HPO) holographic stereograms is analyzed Michael W. Halle in “The Generalized Holographic Stereogram,” Master's Thesis, Massachusetts Institute of Technology, Feb. 1991, which is hereby incorporated by reference herein in its entirety. In general, for HPO holographic stereograms (and other HPO autostereoscopic displays), the best viewer location where a viewer can see an undistorted image is at the plane where the camera (or the camera model in the case of computer graphics images) captured the scene. This is an undesirable constraint on the viewability of autostereoscopic displays. Using several different techniques, one can compensate for the distortion introduced when the viewer is not at the same depth with respect to the autostereoscopic displays as the camera. An anamorphic physical camera can be created with a standard spherical-surfaced lens coupled with a cylindrical lens, or alternately two crossed cylindrical lenses can be used. Using these optics, one can independently adjust horizontal and vertical detail in the stereogram images, thereby avoiding distortion. Since the dynamic displays of the present application typically use computer graphics data (either generated from 3D models or captured using various known techniques) computer graphics techniques are used instead of physical optics.

For a computer graphics camera, horizontal and vertical independence means that perspective calculations can be altered in one direction without affecting the other. Moreover, since the source of the images used for producing autostereoscopic images is typically rendered computer graphics images (or captured digital image data), correcting the distortion as part of the image generation process is a common technique. For example, if the computer graphics images being rendered can be rendered as if seen through the aforementioned physical optics (e.g., using ray tracing where the computer graphics model includes the optics between the scene and the computer graphics camera), then hogel images that account for distortion can be directly rendered. Where ray tracing is impractical (e.g., because of rendering speed or dataset size constraints) another technique for rendering hogel images can be used to “pre-distort” hogel images. This technique is described in M. Halle and A Kropp, “Fast Computer Graphics Rendering for Full Parallax Spatial Displays,” Practical Holography XI, Proc. SPIE, vol. 3011, pages 105-112, Feb. 10-11, 1997, which is hereby incorporated by reference herein in its entirety. While useful for its speed, the techniques of Halle and Kropp often introduce additional (and undesirable) rendering artifacts and are susceptible to problems associated with anti-aliasing. Improvements upon the techniques of Halle and Kropp are discussed in the U.S. Patent entitled “Rendering Methods For Full Parallax Autostereoscopic Displays,” application Ser. No. 09/474,361, naming Mark E. Holzbach and David Chen as inventors, and filed on Dec. 29, 1999, which is hereby incorporated by reference herein in its entirety.

Still another technique for rendering hogel images utilizes a computer graphics camera whose horizontal perspective (in the case of horizontal-parallax-only (HPO) and full parallax holographic stereograms) and vertical perspective (in the case for fill parallax holographic stereograms) are positioned at infinity. Consequently, the images rendered are parallel oblique projections of the computer graphics scene, i.e., each image is formed from one set of parallel rays that correspond to one “direction”. If such images are rendered for each of (or more than) the directions that a hologram printer is capable of printing, then the complete set of images includes all of the image data necessary to assemble all of the hogels. This last technique is particularly useful for creating holographic stereograms from images created by a computer graphics rendering system utilizing imaged-based rendering. Image-based rendering systems typically generate different views of an environment from a set of pre-acquired imagery.

The development of image-based rendering techniques generally, and the application of those techniques to the field of holography have inspired the development of light field rendering as described by, for example, M. Levoy and P. Hanrahan in “Light Field Rendering,” in Proceedings of SIGGRAPH'96, (New Orleans, La., Aug. 4-9, 1996), and in Computer Graphics Proceedings, Annual Conference Series, pages 31-42, ACM SIGGRAPH, 1996, which are hereby incorporated by reference herein in their entirety. The light field represents the amount of light passing through all points in 3D space along all possible directions. It can be represented by a high-dimensional function giving radiance as a function of time, wavelength, position and direction. The light field is relevant to image-based models because images are two-dimensions projections of the light field. Images can then be viewed as “slices” cut through the light field. Additionally, one can construct higher-dimensional computer-base models of the light field using images. A given model can also be used to extract and synthesize new images different from those used to build the model.

Formally, the light field represents the radiance flowing through all the points in a scene in all possible directions. For a given wavelength, one can represent a static light field as a five-dimensional (5D) scalar function L(x, y, z, θ, φ) that gives radiance as a function of location (x, y, z) in 3D space and the direction (θ, (φ) the light is traveling. Note that this definition is equivalent to the definition of plenoptic function. Typical discrete (i.e., those implemented in real computer systems) light-field models represent radiance as a red, green and blue triple, and consider static time-independent light-field data only, thus reducing the dimensionality of the light-field function to five dimensions and three color components. Modeling the light-field thus requires processing and storing a 5D function whose support is the set of all rays in 3D Cartesian space. However, light field models in computer graphics usually restrict the support of the light-field function to four dimensional (4D) oriented line space. Two types of 4D light-field representations have been proposed, those based on planar parameterizations and those based on spherical, or isotropic, parameterizations.

As discussed in U.S. Pat. No. 6,549,308, which is hereby incorporated by reference herein in its entirety, isotropic parameterizations are particularly useful for applications in computer generated holography. Isotropic models, and particularly direction-and-point parameterizations (DPP) introduce less sampling bias than planar parameterizations, thereby leading to a greater uniformity of sample densities. In general, DPP representations are advantageous because they require fewer correction factors than other representations, and thus their parameterization introduces fewer biases in the rendering process. Various light field rendering techniques suitable for the dynamic autostereoscopic displays of the present application are further described in the aforementioned '308 patent, and in U.S. Pat. No. 6,868,177, which is hereby incorporated by reference herein in its entirety.

A massively parallel active hogel display can be a challenging display from an interactive computer graphics rendering perspective. Although a lightweight dataset (e.g., geometry ranging from one to several thousand polygons) can be manipulated and multiple hogel views rendered at real-time rates (e.g., 10 frames per second (fps) or above) on a single GPU graphics card, many datasets of interest are more complex. Urban terrain maps are one example. Consequently, various techniques can be used to composite images for hogel display so that the time-varying elements are rapidly rendered (e.g., vehicles or personnel moving in the urban terrain), while static features (e.g., buildings, streets, etc.) are rendered in advance and re-used. Thus, the aforementioned lightfield rendering techniques can be combined with more conventional polygonal data model rendering techniques such as scanline rendering and rasterization. Still other techniques such as ray casting and ray tracing can be used.

Thus, hogel renderer 130 and 3D image data 135 can include various different types of hardware (e.g., graphics cards, GPUs, graphics workstations, rendering clusters, dedicated ray tracers, etc.), software, and image data as will be understood by those skilled in the art. Moreover, some or all of the hardware and software of hogel renderer 130 can be integrated with display driver 120 as desired.

System 100 also includes elements for calibrating the dynamic autostereoscopic display modules, including calibration system 140 (typically comprising a computer system executing one or more calibration algorithms), correction data 145 (typically derived from the calibration system operation using one or more test patterns) and one or more detectors 147 used to determine actual images, light intensities, etc. produced by display modules 110 during the calibration process. The resulting information can be used by one or more of display driver hardware 120, hogel renderer 130, and display control 150 to adjust the images displayed by display modules 110.

An ideal implementation of display module 110 provides a perfectly regular array of active hogels, each comprising perfectly spaced, ideal lenslets fed with perfectly aligned arrays of hogel data from respective emissive display devices. In reality however, non-uniformities (including distortions) exist in most optical components, and perfect alignment is rarely achievable without great expense. Consequently, system 100 will typically include a manual, semi-automated, or automated calibration process to give the display the ability to correct for various imperfections (e.g., component alignment, optic component quality, variations in emissive display performance, etc.) using software executing in calibration system 140. For example, in an auto-calibration “booting” process, the display system (using external sensor 147) detects misalignments and populates a correction table with correction factors deduced from geometric considerations. Once calibrated, the hogel-data generation algorithm utilizes a correction table in real-time to generate hogel data pre-adapted to imperfections in display modules 110. Various calibration details are discussed in greater detail below.

Finally, display system 100 typically includes display control software and/or hardware 150. This control can provide users with overall system control including sub-system control as necessary. For example, display control 150 can be used to select, load, and interact with dynamic autostereoscopic images displayed using display modules 110. Control 150 can similarly be used to initiate calibration, change calibration parameters, re-calibrate, etc. Control 150 can also be used to adjust basic display parameters including brightness, color, refresh rate, and the like. As with many of the elements illustrated in FIG. 1, display control 150 can be integrated with other system elements, or operate as a separate sub-system. Numerous variations will be apparent to those skilled in the art.

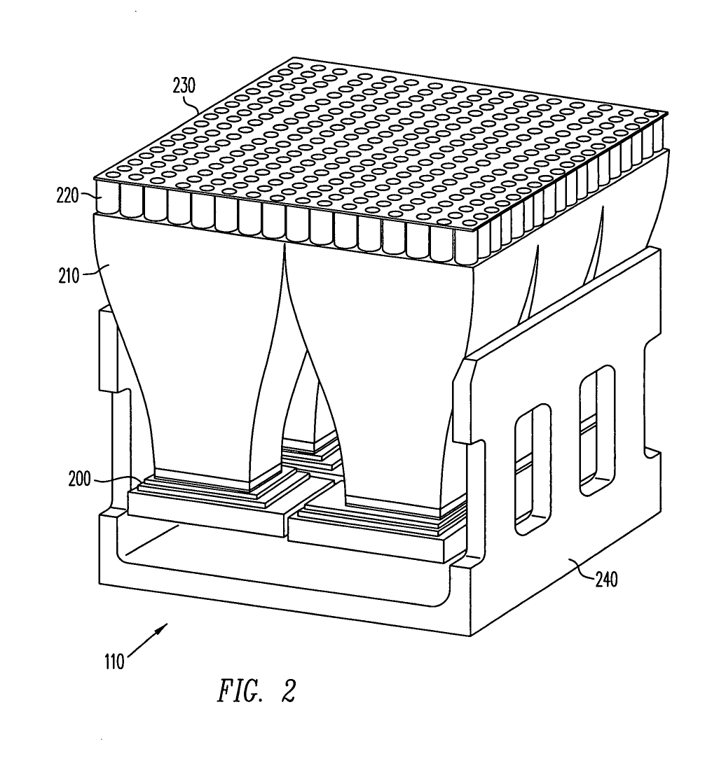

FIG. 2 illustrates an example of a dynamic autostereoscopic display module. Dynamic autostereoscopic display module 110 illustrates the arrangement of optical, electro-optical, and mechanical components in a single module. These basic components include: emissive display 200 which acts as a light source and spatial light modulator, fiber taper 210 (light delivery system), lenslet array 220, aperture mask 230 (e.g., an array of circular apertures designed to block scattered stray light), and support frame 240. Omitted from the figure for simplicity of illustration are various other components including cabling to the emissive displays, display driver hardware, external support structure for securing multiple modules, and various diffusion devices.

While numerous different types of devices can be used as emissive displays 200, including electroluminescent displays, field emission displays, plasma displays, vacuum fluorescent displays, carbon-nanotube displays, and polymeric displays, the examples described below will emphasize organic light-emitting diode (OLED) displays. Emissive displays are particularly useful because they can be relatively compact, and no separate light sources (e.g., lasers, backlighting, etc.) are needed. Pixels can also be very small without fringe fields and other artifacts. Modulated light can be generated very precisely (e.g., planar), making such devices a good fit with lenslet arrays. OLED microdisplay arrays are commercially available in both single color and multiple color configurations, with varying resolutions including, for example, VGA and SVGA resolutions. Examples of such devices are manufactured by eMagin Corporation of Bellevue, Washington. Such OLED microdisplays provide both light source and modulation in a single device, relatively compact device. OLED technology is also rapidly advancing, and will likely be leveraged in future active hogel display systems, especially as brightness and resolution increase. The input signal of a typical OLED device is analog with a pixel count of 852×600. Each OLED device can be used to display data for a portion of a hogel, a single hogel, or multiple hogels, depending on device speed and resolution, as well as the desired resolution of the overall autostereoscopic display.

In some embodiments where OLED arrays are used, the input signal is analog and has an unusual resolution (852×600). In other embodiments, the digital-to-OLED connection can be made more direct. However, in various embodiments the hogel data array will pass through six (per module) analog circuits on its way to the OLED devices. Therefore, during alignment and calibration, each OLED device is adjusted to have equal (or at least approximately equal) light levels and linearity (i.e., gamma correction). Grey-level test patterns can aid in this process.

As illustrated in FIG. 2, module 110 includes six OLED microdisplays arranged in close proximity to each other. Modules can variously include fewer or more microdisplays. Relative spacing of microdisplays in a particular module (or from one module to the next) largely depends on the size of the microdisplay, including, for example, the printed circuit board and/or device package on which it is fabricated. For example, the drive electronics of displays 200 reside on a small stacked printed-circuit board, which is sufficiently compact to fit in the limited space beneath fiber taper 210. As illustrated, emissive displays 200 cannot be have their display edges located immediately adjacent to each other, e.g., because of device packaging. Consequently, light delivery systems or light pipes such as fiber taper 210 are used to gather images from multiple displays 200 and present them as a single seamless (or relatively seamless) image. In still other embodiments, image delivery systems including one or more lenses, e.g., projector optics, mirrors, etc., can be used to deliver images produced by the emissive displays to other portions of the display module.

The light-emitting surface (“active area”) of emissive displays 200 is covered with a thin fiber faceplate, which efficiently delivers light from the emissive material to the surface with only slight blurring and little scattering. During module assembly, the small end of fiber taper 210 is typically optically index-matched and cemented to the faceplate of the emissive displays 200. In some implementations (illustrated in greater detail below), separately addressable emissive display devices can be fabricated or combined in adequate proximity to each other to eliminate the need for a fiber taper fiber bundle, or other light pipe structure. In such embodiments, lenslet array 220 can be located in close proximity to or directly attached to the emissive display devices. The fiber taper also provides a mechanical spine, holding together the optical and electro-optical components of the module. In many embodiments, index matching techniques (e.g., the use of index matching fluids, adhesives, etc.) are used to couple emissive displays to suitable light pipes and/or lenslet arrays. Fiber tapers 210 often magnify (e.g., 2:1) the hogel data array emitted by emissive displays 200 and deliver it as a light field to lenslet array 220. Finally, light emitted by the lenslet array passes through black aperture mask 230 to block scattered stray light.

Each module is designed to be assembled into an N-by-M grid to form a display system. To help modularize the sub-components, module frame 240 supports the fiber tapers and provides mounting onto a display base plate (not shown). The module frame features mounting bosses that are machined/lapped flat with respect to each other. These bosses present a stable mounting surface against the display base plate used to locate all modules to form a contiguous emissive display. The precise flat surface helps to minimize stresses produced when a module is bolted to a base plate. Cutouts along the end and side of module frame 240 not only provide for ventilation between modules but also reduce the stiffness of the frame in the planar direction ensuring lower stresses produced by thermal changes. A small gap between module frames also allows fiber taper bundles to determine the precise relative positions of each module. The optical stack and module frame can be cemented together using fixture or jig to keep the module's bottom surface (defined by the mounting bosses) planar to the face of the fiber taper bundles. Once their relative positions are established by the fixture, UV curable epoxy can be used to fix their assembly. Small pockets can also be milled into the subframe along the glue line and serve to anchor the cured epoxy.

Special consideration is given to stiffness of the mechanical support in general and its effect on stresses on the glass components due to thermal changes and thermal gradients. For example, the main plate can be manufactured from a low CTE (coefficient of thermal expansion) material. Also, lateral compliance is built into the module frame itself, reducing coupling stiffness of the modules to the main plate. This structure described above provides a flat and uniform active hogel display surface that is dimensionally stable and insensitive to moderate temperature changes while protecting the sensitive glass components inside.

As noted above, the generation of hogel data typically includes numerical corrections to account for misalignments and non-uniformities in the display. Generation algorithms utilize, for example, a correction table populated with correction factors that were deduced during an initial calibration process. Hogel data for each module is typically generated on digital graphics hardware dedicated to that one module, but can be divided among several instances of graphics hardware (to increase speed). Similarly, hogel data for multiple modules can be calculated on common graphics hardware, given adequate computing power. However calculated, hogel data is divided into some number of streams (in this case six) to span the six emissive devices within each module. This splitting is accomplished by the digital graphics hardware in real time. In the process, each data stream is converted to an analog signal (with video bandwidth), biased and amplified before being fed into the microdisplays. For other types of emissive displays (or other signal formats) the applied signal may be digitally encoded.

The basic design illustrated in FIG. 2 emphasizes scalability, utilizing a number of self-contained scalable modules. Again, there need not be a one-to-one correspondence between emissive displays and hogels displayed by a module. So, for example, module 110 can have a small exit array (e.g., 16×18) of active hogels and contains all of the components for pixel delivery and optical processing in a compact footprint allowing for seamless assembly with other modules. Conceptually, an active hogel display is designed to digitally construct an optical wavefront (in real-time or near-real-time) to produce a 3D image, mimicking the reconstructed wavefront recorded optically in traditional holography. Each emissive display is capable of controlling the amount of light emitted in a wide range of directions (depending in part on any fiber taper/bundle used, the lenslet array, masking, and any diffusion devices) as dictated by a set of hogel data. Together, the active hogel array acts as an optical wavefront decoder, converting wavefront samples (hogel data) from the virtual world into the real world. In many embodiments, the lenslets need only operate to channel light (akin to non-imaging optics) rather than focus light. Consequently, they can be made relatively inexpensively while still achieving acceptable performance.

Whatever technique is used to display hogel data, generation of hogel data should generally satisfy many rules of information theory, including, for example, the sampling theorem. The sampling theorem describes a process for sampling a signal (e.g., a 3D image) and later reconstructing a likeness of the signal with acceptable fidelity. Applied to active hogel displays, the process is as follows: (1) band-limit the (virtual) wavefront that represents the 3D image, i.e., limit variations in each dimension to some maximum; (2) generate the samples in each dimension with a spacing of greater than 2 samples per period of the maximum variation; and (3) construct the wavefront from the samples using a low-pass filter (or equivalent) that allows only the variations that are less than the limits set in step (1).

An optical wavefront exists in four dimensions: 2 spatial (i.e., x and y) and 2 directional (i.e., a 2D vector representing the direction of a particular point in the wavefront). This can be thought of as a surface—flat or otherwise—in which each infinitesimally small point (indexed by x and y) is described by the amount of light propagating from this point in a wide range of directions. The behavior of the light at a particular point is described by an intensity function of the directional vector, which is often referred to as the k-vector. This sample of the wavefront, containing directional information, is called a hogel, short for holographic element and in keeping with a hogel's ability to describe the behavior of an optical wavefront produced holographically or otherwise. Therefore, the wavefront is described as an x-y array of hogels, i.e., SUM[I_{xy}(kₓk_{y})], summed over the full range of propagation directions (k) and spatial extent (x and y).

The sampling theorem allows us to determine the minimum number of samples required to faithfully represent a 3D image of a particular depth and resolution. The following table gives approximate minimum sample counts for hogel data given image quality (a strong function of hogel spacing) and maximum usable image depth, and assuming a 90-degree full range of emission directions:

TABLE 1

| | maximum depth = 300 mm | | maximum depth = 600 mm | |
|---|---|---|---|---|
| | number of | pixel | number of | pixel |
| hogel | samples (in each | spacing, | samples (in each | spacing, |
| spacing | dimension) | microns | dimension) | microns |
| 3.0 mm | 80 | 37.5 | 160 | 18.75 |
| 2.0 mm | 120 | 16.7 | 240 | 8.33 |
| 1.5 mm | 160 | 9.4 | 320 | 4.69 |
| 1.2 mm | 200 | 6.0 | 400 | 3.00 |
| 1.0 mm | 240 | 4.17 | 480 | 2.08 |
| 0.8 mm | 300 | 2.67 | 600 | 1.33 |
| 0.7 mm | 343 | 2.04 | 686 | 1.02 |
| 0.6 mm | 400 | 1.50 | 800 | 0.75 |
| 0.5 mm | 480 | 1.04 | 960 | 0.52 |
| 0.4 mm | 600 | 0.67 | 1200 | 0.33 |

Optical systems become difficult to design and build at scales equal to the wavelength of light, e.g., approximately 0.5 microns. Present optical modulators have pixel sizes as small as 5-6 microns, but optical modulators with pixel sizes of approximately 0.5 microns are not practical. For electro-optic modulators (e.g., liquid crystal SLMs), the electric fields used to address each pixel typically exhibit too much crosstalk and non-uniformity. In emissive light modulators (e.g., an OLED array), brightness is limited by small pixel size: a 0.5-micron square pixel would typically need 900 times greater irradiance to produce the same optical power as a 15-micron square pixel. Even if a practical light modulator can be built with 0.5-micron pixels, light exiting the pixel would rapidly diverge due to diffraction, making light-channeling difficult. Consequently, each pixel should generally be no smaller than the wavelength of the modulated light.

In considering various architectures for active hogel displays, generating hogel data and convert it into a wavefront and subsequently a 3D image, uses three functional units: (1) hogel data generator; (2) light modulation/delivery system; and (3) light-channeling optics (e.g., lenslet array, diffusers, aperture masks, etc.). The purpose of the light modulation/delivery system is to generate a field of light that is modulated by hogel data, and to deliver this light to the light-channeling optics—generally a plane immediately below the lenslets. At this plane, each delivered pixel is a representation of one piece of hogel data. It should be spatially sharp, e.g., the delivered pixels are spaced by approximately 30 microns and as narrow as possible. A simple single active hogel can comprise a light modulator beneath a lenslet. The modulator, fed hogel data, performs as the light modulation/delivery system—either as an emitter of modulated light, or with the help of a light source. The lenslet—perhaps a compound lens—acts as the light-channeling optics. The active hogel display is then an array of such active hogels, arranged in a grid that is typically square or hexagonal, but may be rectangular or perhaps unevenly spaced. Note that the light modulator may be a virtual modulator, e.g., the projection of a real spatial light modulator (SLM) from, for example, a projector up to the underside of the lenslet array.

Purposeful introduction of blur via display module optics is also useful in providing a suitable dynamic autostereoscopic display. Given a hogel spacing, a number of directional samples (i.e., number of views), and a total range of angles (e.g., a 90-degree viewing zone), sampling theory can be used to determine how much blur is desirable. This information combined with other system parameters is useful in determining how much resolving power the lenslets should have. Again, using a simplified model, the plane of the light modulator is an array of pixels that modulate light and act as a source for the lenslet, which emits light upwards, i.e., in a range of z-positive directions. Light emitted from a single lenslet contains a range of directional information, i.e., an angular spread of k-vector components. In the ideal case of a diffraction-limited imaging system, imaging light from a single point on the modulator plane light exits the lenslet with a single k-vector component, i.e., the light is collimated. For an imperfect lenslet, the k-vectors will have a non-zero spread, which we will represent by angle αᵣ. For an extended source at the plane of the modulator—a pixel of some non-zero width—the k-vectors will have a non-zero spread, which we will represent by angle αₓ. The total spread, α_{Total}, can be determined as α_{Total}²=αₓ²+αᵣ² assuming that all other contributions to k-vector spread (i.e., “blur”) are insignificant.

The pixels contain information about the desired image. Together as hogel data they represent a sampled wavefront of light that would pass through the hogel point while propagating to (or from) a real version of the 3D scene. Each pixel contains a directional sample of light emitted by the desired scene (i.e., a sample representing a single k-vector component), as determined by, for example, a computer graphics rendering calculation. Assuming N samples that are evenly angularly spaced across the full range of k-vector angular space, Ω, sampling is at a pitch of one sample per ΩN. Note that the sampling theorem thus requires that the scene content be band-limited to contain no angularly-dependant variation (information) above the spatial frequency of N/2Ω. To properly reconstruct a wavefront—one that behaves as would a (band-limited) wavefront from a real version of the scene—the samples should pass through a filter providing low-pass spatial filtering. Such a filter passes only the information below half the sampling pitch, filtering out the higher-order components, and thereby avoiding aliasing artifacts. Consequently, the low-pass cutoff frequency for our lenslet system should be at the band-limit of the original signal, N/Ω. A lower cutoff frequency will lose some of the more rapidly varying components of the wavefront, while a higher frequency cutoff allows unwanted artifacts to degrade the wavefront and therefore the image.

Expressed in the spatial domain, the samples should be convolved with a kernel of some minimum width to faithfully reconstruct the smooth, band-limited wavefront of which the pixels are only a representation. Such a kernel should have an angular full-width of at least twice the sample spacing, i.e., >2·Ω/N. If the full-width of this kernel is C·Ω/N, then the system should add an amount of blur (i.e., k-vector spread) that is C·Ω/. The choice of this kernel width—the equivalent of choosing the low-pass cutoff frequency—is important for proper reconstruction of the wavefront. The “overlap” factor C should have a value greater than 2 to faithfully reconstruct the wavefront.

Assuming the optical lenslet system is designed to produce the desired total blur, then (C·Ω/N)²=αₓ²+αᵣ² (recalling that this includes only the blur from the non-zero extent of the modulator pixel and from the non-diffraction-limited resolving ability of the lenslet). Consequently, a description of the pixel blur αₓ is desirable so an expression for the necessary resolving power of the lenslet can be extracted. Assuming the system is designed so the extent of the modulator covers the full range of angles (e.g., the pixels are spaced with their centers every xₚ), the total width of the modulator's active region is N·xₚ. If a pixel spans a full 1/N of the active region of the modulator, it has the effect of contributing to k-vectors that have a directional range of (on average) Ω/N. For pixels with smaller fill factors, the angular spread is proportionally less. If the modulator has a one-dimensional fill factor of Fₘ, the pixel is an extended source of width xp,Fm and contributes k-vector spreading of αₓ=Fₘ·Ω/N.

The resolving power of the lenslet can be defined with a “spotsize.” This is the minimum size spot that can be imaged by the lenslet, in the traditional imaging sense. In our example at the modulator plane it is the smallest that the lenslet can focus a collimated beam of light that enters the lenslet's exit aperture. In other words, a beam containing a single k-vector direction (and heading backwards and entering the lenslet through its exit aperture) is focused at the modulator plane no smaller than the spotsize. Since there is a mapping between the width of the modulator and the full range of k-vector directions, Ω, the same ratio of modulator width to angular extent can be applied, i.e., αᵣ=spotsize·Ω/(N·xₚ), recalling that the modulator's active region has extent N·xₚ. Although this is an approximation, it enables us to represent a lateral extent at the plane of the modulator (e.g., spotsize) with an angular extent at the exit aperture (e.g., αᵣ). Combining these last two equations, and the blur due to the extended source (αₓ=Fₘ·Ω/N), provides (C·Ω/N)²=(Fₘ·Ω/N)²+spotsize²·Ω²/(N·xₚ)², simplifying to spotsize=xₚ·(C²-Fₘ²)^{1/2}.

Thus, when designing a lenslet system for an active hogel array, it should have a spotsize bigger than the pixel spacing by a factor of (C²-Fₘ²)^{1/2}. Given C is at least 2—for proper reconstruction of the sampled wavefront—this factor is a minimum of 1.73, for modulator fill factor of Fₘ=100%. For more practical values of C=2.2 and Fₘ=90%, this factor becomes approximately 2. Therefore the “spotsize” should be about twice the width of a single pixel in the modulator. In other words, in a properly designed active hogel array, the lenslets need not have a resolving power that is as tight as the pixel spacing; the lenslet can be designed to be somewhat sloppy. Note that the parameter N—the number of angular samples—does not appear in this relation, nor does the hogel spacing. However, the pixel spacing of the modulator—xₚ—has been chosen based on hogel spacing and N, xₚ=Wₕ/N, where wₕ is the hogel spacing and it has been assumed that the width of the active region of the modulator is the same as the hogel spacing. Note that other factors such as hogel spacing (wₕ) and the number of angular samples (N) will have a significant impact on lenslet design.

The exit aperture for each active hogel is the area through which light passes. In general, the exit aperture is different for light emitted in different directions. The hogel spacing is the distance from the center of one hogel to the next, and the fill factor is the ratio of the area of the exit aperture to the area of the active hogel. For example, 2-mm hogel spacing with 2-mm diameter exit apertures will have a fill factor (“ff”) of pi/4 or approximately 0.785. Low fill factors tend to degrade image quality. High fill factors are desirable, but more difficult to obtain.

FIG. 3 illustrates an example of an optical fiber taper that can be used in dynamic autostereoscopic display modules. Here, six separate fiber tapers 300 have their large faces fused together to form a single component with the optical and structural properties discussed above. Note that light modulation devices 310 are shown for reference. Coherent optical fiber bundles propagate a light field from an entrance plane to an exit plane while retaining spatial information. Although each of the fiber bundles 300 are tapered (allowing for magnification or demagnification), such bundles need not be tapered. Fiber bundles and tapered fiber bundles are produced by various companies including Schott North America, Inc. Each taper 300 is formed by first bundling a large number of multimode optical fibers in a hexagonal bundle fusing them together using heat, and then drawing one end to produce the desired taper. Taper bundles with desired shapes, e.g., rectangular-faced tapers, can be fabricated with a precision of less than 0.2 mm. Light emitted by an emissive display coupled to the small end of such a taper is magnified and relayed to the lenslet plane with less than 6 microns of blur or displacement. Tapers also provide precise control of the diffusion angle of light beneath the lenslets. In general, light at this plane must diverge by a large angle (60 degrees full-angle, or more) to achieve high active hogel fill factors. In some embodiments, optical diffusers are used to provide this function. However, light exiting many fiber tapers diverges by approximately 60 degrees (full angle) due to the underlying structure of the optical fibers. In still other embodiments, a fiber core diameter can be specified to produce an optimal divergence angle, yielding both a high fill factor and minimal crosstalk.

As noted above, optimal interfacing between emissive displays and fiber tapers may include replacing a standard glass cover that exists on the emissive display with a fiber optic faceplate, enabling the display to produce an image at the topmost surface of the microdisplay component. Fiber optic faceplates typically have no effect on color, and do not compromise the high-resolution and high-contrast of various emissive display devices. Fiber tapers can be fabricated in various sizes, shapes, and configurations: e.g., from round to round, from square to square, from round to square or rectangular; sizes range up to 100 mm in diameter or larger, typical magnification ratios range up to 3:1 or larger; and common fiber sizes range from 6 μm to 25 μm at the large end, and are typically in the 3 μm to 6 μm range on the small end.

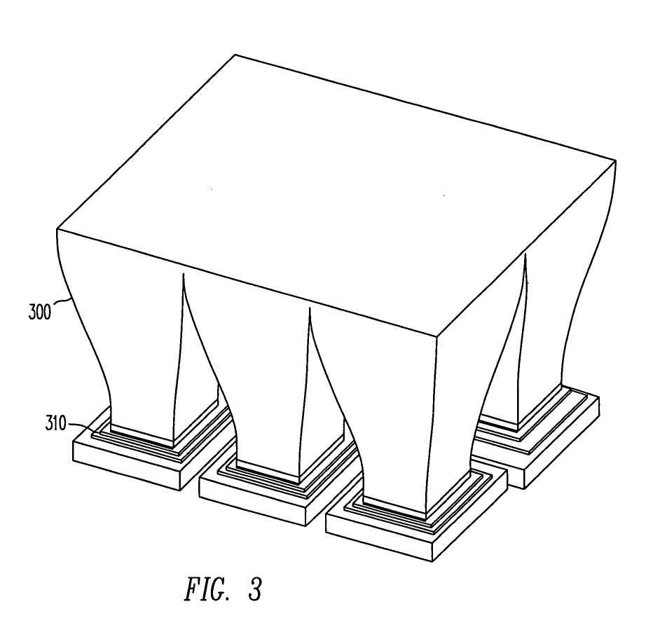

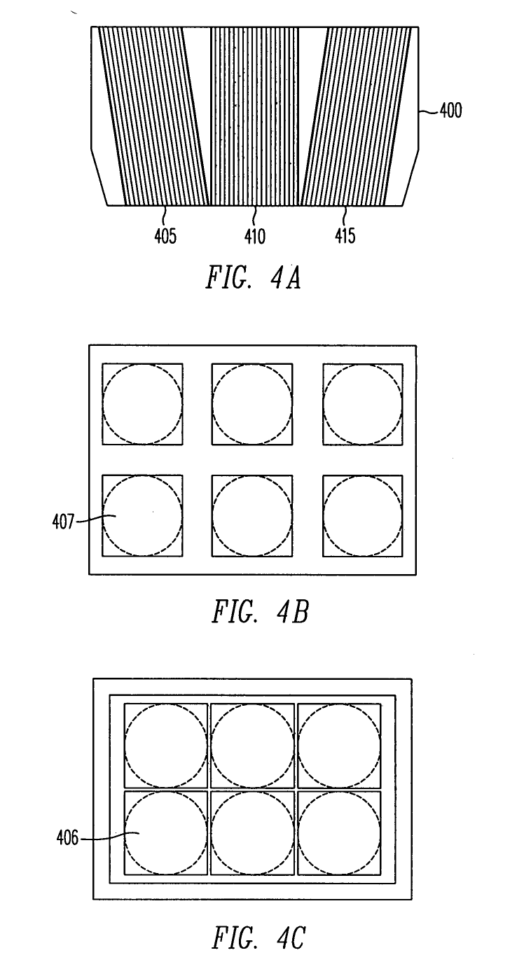

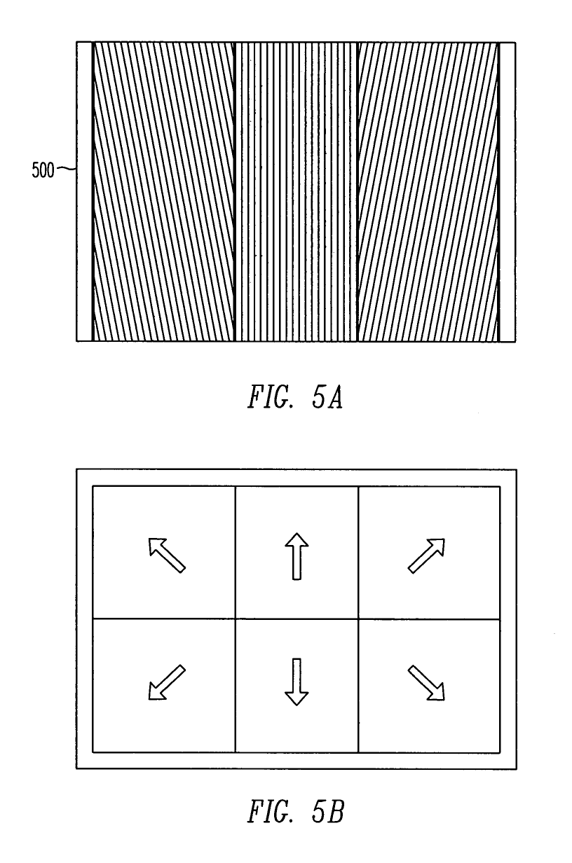

In addition to the tapered fiber bundles of FIG. 3, arrays of non-tapered fiber bundles, as illustrated in FIGS. 4A-5B, can also be used to deliver light in dynamic autostereoscopic display modules. Conventional fiber bundles attempt to maintain the image profile incident to the bundle. Instead, the fiber bundles of FIGS. 4A-5B use a collection of fiber bundles or image conduits specially arranged and assembled so that an incident image is not perfectly maintained, but is instead manipulated in a predetermined way. Specifically, the light pattern or image is divided into subsections which are spread apart upon exiting the device. This “spreader” optic does not magnify the image, but can be used to more closely pack images or even combine images. Moreover, some embodiments can help to reduce crosstalk between light from adjacent fiber bundles by providing separation of respective fiber bundles.

FIG. 4A illustrates the basic design in cross-section. Ferrule or support 400 supports separate fiber bundles 405, 410, and 415. In general, ferrule 400 can support an array of any number of fiber bundles, in this case six (see, FIGS. 4B and 4C). The array of fiber bundles is constructed such that light entering one end (e.g., the bottom of the bundle) emerges from the other end of the device with a different spatial arrangement. Ferrule 400 holds the fiber bundles in place, creating a solid structure that is mechanically stable and optically precise. In one embodiment, the array is constructed as a spreader to separate a number of entrance apertures, creating an array of exit apertures that maintain the entering light pattern but with added space between. Thus, fiber bundle 405 is oriented at an angle such that light entering the bundle at bottom face 406 emerges at top face 407 shifted away from the center of the device (i.e., shifted in both x and y as defined in FIG. 4B or 4C by the plane of the figure). Note that the optical fibers of bundle 405 are generally parallel to each other, but not parallel to other fibers in the same array. Similarly, fiber bundle 410 is oriented at an angle such that light entering the bundle at the bottom (FIG. 4C) emerges at top (FIG. 4B) shifted away from the center of the device in the y direction as defined by the plane of the figure.

In general, light entering each of the entrance apertures emerges from the exit apertures, but with additional interstitial spacing. FIG. 4A illustrates the relative tilting of fiber bundles to achieve image separation, but other techniques, e.g., including twists or turns in the fiber bundles, can also be used. Ferrule 400 can also be used during fabrication of the device to maintain proper alignment of the bundles and to aid in cutting, grinding, and/or polishing respective fiber bundles. Although illustrated as a 2×3 array in FIGS. 4B and 4C, the fiber bundle array can generally be fabricated in any array configuration, as desired for a particular application.

FIGS. 5A-5B illustrate another example of a bundled optical fiber system that can be used in dynamic autostereoscopic display modules. Like the device of FIGS. 4A-4C, the bundle array illustrated includes various separate bundles of parallel (or substantially parallel) fibers where each bundle is oriented at a specified angle with respect to the center of the device (e.g., the surface normal). Here, however, the fiber bundles of fiber bundle array 500 are not held in place by a ferrule or mount, but instead are cut into small blocks and assembled into a composite structure. In some embodiments, these fiber bundles are fused together in the same manner in which the previously described fiber tapers are formed. As illustrated by the arrows in FIG. 5B (which shows the top surface of array 500) light emerges from the top surface in a different spatial configuration from that when it entered the array.

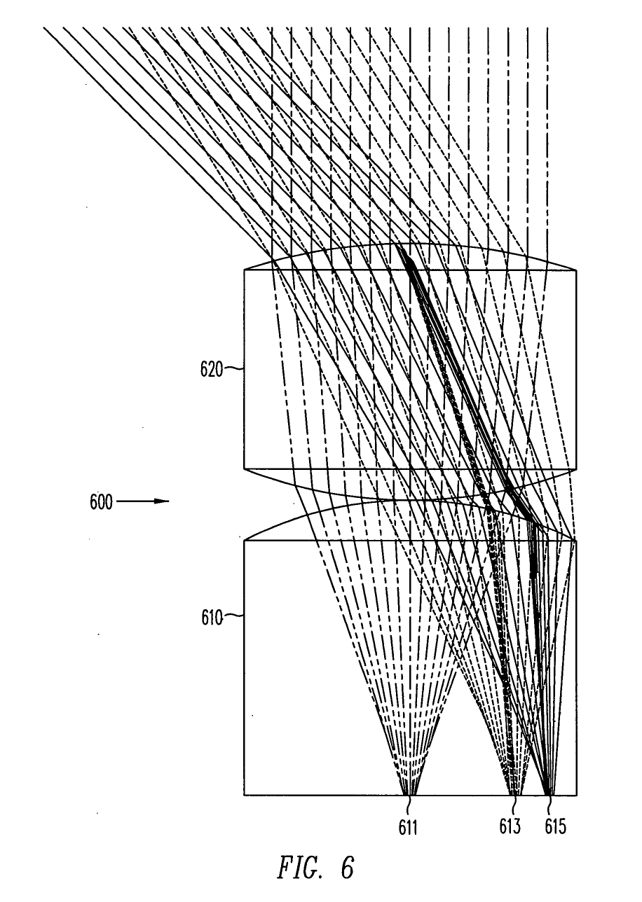

Returning briefly to FIG. 2, lenslet array 220 provides a regular array of compound lenses. In one implementation, each of the two-element compound lens is a plano-convex spherical lens immediately below a biconvex spherical lens. FIG. 6 illustrates an example of a multiple element lenslet system 600 that can be used in dynamic autostereoscopic display modules. Light enters plano-convex lens 610 from below. A small point of light at the bottom plane (e.g., 611, 613, or 615, such light emitted by a single fiber in the fiber taper) emerges from bi-convex lens 620 fairly well collimated. Simulations and measurements show divergence of 100 milliradians or less can be achieved over a range of ±45 degrees. The ability to control the divergence of light emitted over a range of 90 degrees demonstrates, the usefulness of this approach. Furthermore, note that the light emerges from lens 620 with a fairly high fill factor, i.e., it emerges from a large fraction of the area of the lens. This is made possible by the compound lens. In contrast, with a single element lens the exit aperture is difficult to fill.

Such lens arrays can be fabricated in a number of ways including: using two separate arrays joined together, fabricating a single device using a “honeycomb” or “chicken-wire” support structure for aligning the separate lenses, joining lenses with a suitable optical quality adhesive or plastic, etc. Manufacturing techniques such as extrusion, injection molding, compression molding, grinding, and the like. Various different materials can be used such as polycarbonate, styrene, polyamides, polysulfones, optical glasses, and the like.

The lenses forming the lenslet array can be fabricated using vitreous materials such as glass or fused silica. In such embodiments, individual lenses may be separately fabricated, and then subsequently oriented in or on a suitable structure (e.g., a jig, mesh, or other layout structure) before final assembly of the array. In other embodiments, the lenslet array will be fabricated using polymeric materials and using well known processes including fabrication of a master and subsequent replication using the master to form end-product lenslet arrays. In general, the particular manufacturing process chosen can depend on the scale of the lenses, complexity of the design, and the desired precision. Since each lenslet described in the present application can include multiple lens elements, multiple arrays can be manufactured and subsequently joined. In still other examples, one process may be used for mastering one lens or optical surface, while another process is used to fabricate another lens or optical surface of the lenslet. For example, molds for microoptics can be mastered by mechanical means, e.g., a metal die is fashioned with the appropriate surface(s) using a suitable cutting tool such as a diamond cutting tool. Similarly, rotationally-symmetrical lenses can be milled or ground in a metal die, and can be replicated so as to tile in an edge-to-edge manner. Single-point diamond turning can be used to master diverse optics, including hybrid refractive/diffractive lenses, on a wide range of scales. Metallic masters cal also be used to fabricate other dies (e.g., electroforming a nickel die on a copper master) which in turn are used for lenslet array molding, extrusion, or stamping. Still other processes can be employed for the simultaneous development of a multiple optical surfaces on a single substrate. Examples of such processes include: fluid self-assembly, droplet deposition, selective laser curing in photopolymer, photoresist reflow, direct writing in photoresist, grayscale photolithography, and modified milling. More detailed examples of lenslet array fabrication are described in U.S. Pat. No. 6,721,101.

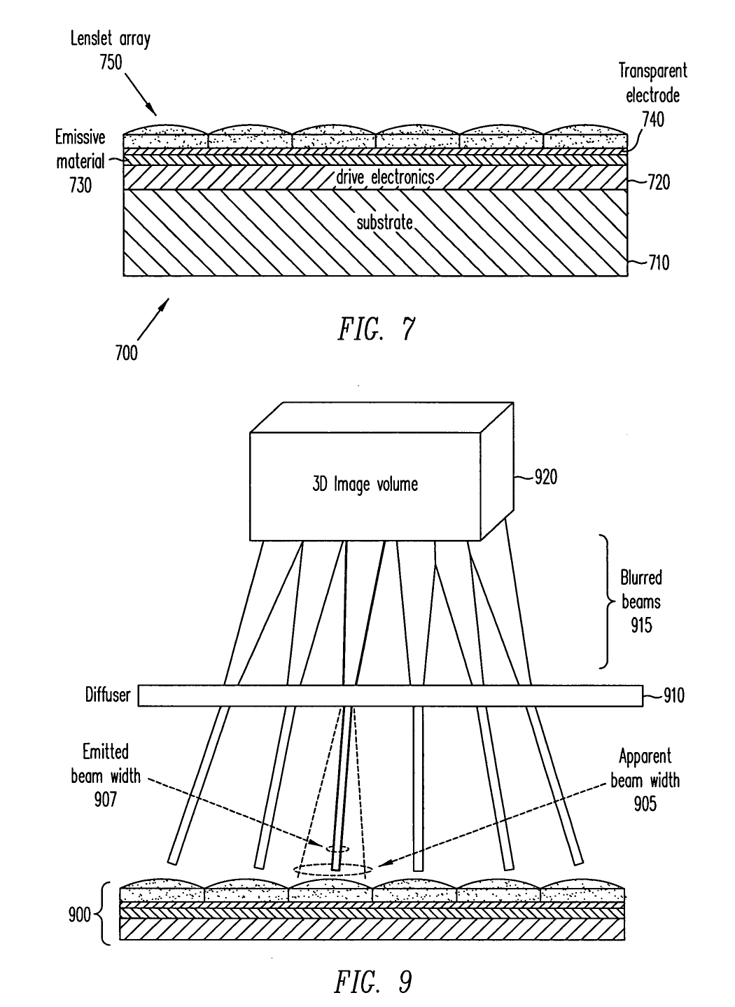

As noted above, fiber tapers and fiber bundle arrays can be useful in transmitting light from emissive displays to the lenslet array, particularly where emissive displays cannot be so closely packed as to be seamless or nearly seamless. However, FIG. 7 illustrates an example of a dynamic autostereoscopic display module where optical fiber tapers or bundles are not used. Display module 700 forgoes the use of fiber tapers/bundles by attaching lenslet array 750 very close to the emissive device. Display module 700 includes a substrate 710 providing adequate mechanical stability for the module. Substrate 710 can be fabricated out of a variety of materials including, for example, metal, plastics, and printed circuit board materials. Drive electronics 720 are mounted on substrate 710 and below emissive material 730. This is a common configuration for emissive display devices such as OLED microdisplays. Module 700 can be fabricated to include a single emissive device (e.g., the emissive layer is addressed/driven as a single micro display), or with multiple emissive devices on the same substrate. As the example of FIG. 7 illustrates and OLED device, module 700 includes a transparent electrode 740, common to these and other emissive display devices. Finally, lenslet array 750 is attached on top of transparent electrode 740.

As will be understood by those having ordinary skill in the art, many variations of the basic design of module 700 can be implemented. For example, in some embodiments, lenslet array 750 is fabricated separately and subsequently joined to the rest of module 700 using a suitable adhesive and/or index matching material. In other embodiments, lenslet array 750 is fabricated directly on top of the emissive display using one or more of the aforementioned lenslet fabrication techniques. Similarly, various different types of emissive displays can be used in this module. In still other embodiments, fiber optic faceplates (typically having thicknesses of less than 1 mm) can be used between lenslet array 750 and the emissive display.

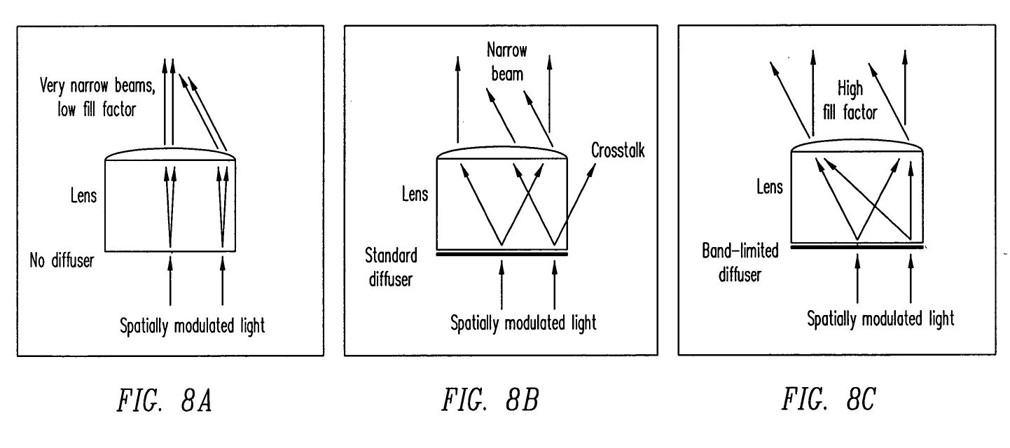

As noted above, directional control of light in a dynamic autostereoscopic emissive display system is enhanced by careful control of blur. Blur can be controlled in a variety of different ways, including conventional diffusers and band-limited diffusers. FIGS. 8A-8C illustrate the use of optical diffusers in dynamic autostereoscopic display modules.

The lenslets or lenslet arrays described in the present application can convert spatially modulated light into directionally modulated light. Typically, the spatially modulated light is fairly well collimated, i.e., has a small angular spread at the input plane of the lens. A traditional optical diffuser (such as ground glass) placed at this plane causes the light to have a larger angular spread, creating a beam of light that emerges from the lens with a higher fill factor. However, the widely diverging light—especially well off the optical axis of the lens—is more likely to be partially (or fully) clipped, reducing emitted power and contributing to crosstalk. Crosstalk occurs in an array of such lenses, when light undesirably spills from one lens into a neighboring lens.

Without a diffuser (FIG. 8A) light propagation produces a very low fill factor. Beam spread is generally minimal, or else achieved using more complex optics. Because the disclosed dynamic autostereoscopic emissive displays typically include an array of such lens emitters, the low fill factor creates dark artifacts, which might appears as a periodic dark mask or mesh—reducing image fidelity and weakening the 3D effect.

With a standard diffuser (FIG. 8B) light propagation is less precise, especially for off-axis light. The standard diffuser spreads off-axis modulated light (shown to the right in the figure) but does not change the mean angle. Consequently, light escapes from the lens at the side and creates crosstalk (i.e., scatters into a neighboring lens and causes noise). The light that does propagate through the lens has a narrower beam width and therefore a smaller fill factor. A diffuser with less spread would create less crosstalk, but would reduce overall fill factor for all beams.

Band-limited diffusers (FIG. 8C) control the precise directions of light, allowing for better optical performance from simple optical systems. A band-limited diffuser can be tailored to minimize crosstalk while spreading light to create a high fill factor. Two important characteristics of band-limited diffusers are: (1) they add a precise amount of angular spread with a predictable irradiance profile; and (2) the angular spread varies across the spatial extent of the diffuser, e.g., causing diffused light to have different amount of spread and/or different mean direction of propagation depending on where it passes through the diffuser. Light passing through the center of a band-limited diffuser is spread at a precise angle, and propagates in a specific direction (in this case, unchanged). The spread allows the optical system (a lens) to create a wide beam, with a high fill factor (the ratio of the area of the beam cross-section with the area occupied by the optic). For an off-axis portion of the modulated light (shown to the right in figure), the band-limited diffuser angles the light toward the center of the lens, preventing light from escaping from the lens at the side and creating crosstalk. The light is also spread by an amount that gives rise to a high fill factor.

Various different devices can be used as band limited diffusers, and various different fabrication techniques can be used to produce such devices. Examples include: uniform diffusers, binary diffusers, one-dimensional diffusers, two-dimensional diffusers, diffractive optical elements that scatter light uniformly throughout specified angular regions, Lambertian diffusers and truly random surfaces that scatter light uniformly within a specified range of scattering angles, and produce no scattering outside this range (e.g., T. A. Leskova et al. Physics of the Solid State, May 1999, Volume 41, Issue 5, pp. 835-841). Examples of companies producing related diffuser devices include Thor Labs and Physical Optics Corp.

Note that some autostereoscopic displays attempt to create a seamless array of exit pupils (view zones) at a particular viewing distance. Optical diffusers are often used to blur the delineation between exit pupils. Instead of (or in addition to) use of separate optical diffusers, lower quality lenslet arrays can be used to add blur to emitted light. Thus, for example, lenslet arrays 750 and 220 can be designed with sub-optimal focusing, lower quality optical materials, or sub-optimal surface finishing to introduce a measured amount of blur that might otherwise be provided by a dedicated diffuser. In still other embodiments, diffuser devices can be integrated into the lenslet array employed in a display module. Moreover, different sections of a display module, different display modules, etc., can have differing amounts of blur or employ different diffusers, levels of diffusion, and the like.

FIG. 9 illustrates still another use of optical diffusers in dynamic autostereoscopic display modules. Display module 900 utilizes a diffuser 910 located above the surface of module 900 to provide additional blur/diffusion. For example, image volume 920 is now formed from various blurred beams 915. As opposed to the actual emitted beam width 907, blurred beams 915 have a larger apparent beam width 905. Diffuser 910 can be a standard diffuser or as specialized diffuser such as a band limited diffuser, and can be used instead of or in addition to the diffusers discussed above. Since diffuser 910 is typically located some distance away from the surface of display module 900, it can be separately mounted to the overall display, i.e., a single diffuser servicing multiple display modules. In other embodiments, diffuser 910 is assembled as part of the display module. Thus, diffuser 910 adds a selected amount of blur to the emitted beams, making the beams appear to have higher fill and reducing the distraction of emission-plane artifacts associated with low fill-factor emissive arrays.

Returning to FIG. 1, additional details of the calibration or auto-calibration system are described. In general, the calibration system automatically measures the corrections required to improve image quality in an imperfect dynamic autostereoscopic emissive display. Adaptive optics techniques generally involve detecting image imperfections to adjust the optics of an imaging system to improve image focus. However, the present calibration systems uses sensor input and software to adjust or correct the images displayed on the underlying emissive displays for proper 3D image generation in the dynamic autostereoscopic emissive display. Many types of corrections can be implemented, included unique corrections per display element and per primary color, rather than a global correction. Instead of adjusting optics (as in adaptive optics), auto-calibration/correction adjusts the data to compensate for imperfect optics and imperfect alignment of display module components. The auto-calibration routine generates a set of data (e.g., a correction table) that is subsequently used to generate data for the display modules, taking into account imperfections in alignment, optical characteristics and non-uniformities (e.g., brightness, efficiency, optical power).

In many types of auto-stereoscopic displays, a large array of data is computed and transferred to an optical system that converts the data into a 3D image. For example, at a given location of the display system, a lens can convert spatially modulated light into directionally modulated light. Often, the display is designed to have a regular array of optical elements, e.g., uniformly spaced, lenslets fed with perfectly aligned arrays of data in the form of modulated light. In reality, non-uniformities (including distortions) exist in some or all of the optical components, and perfect alignment is rarely attainable at any cost. However, the data can be generated to include numerical corrections to account for misalignments and non-uniformities in the display optics. The generation algorithm utilizes a correction table, populated with correction factors that were deduced during an initial auto-calibration process. Once calibrated, the data generation algorithm utilizes a correction table in real time to generate data pre-adapted to imperfections in the display optics. The desired result is a more predictable mapping between data and direction of emitted light—and subsequently a higher quality image. This process also corrects for non-uniform brightness, allowing the display system to produce a uniform brightness. Auto-calibration can provide various types of correction including: automatically determining what type of corrections can improve image quality; unique corrections for each display element rather than overall; unique corrections for each primary color (e.g., red, green, blue) within each display element; and detecting necessary corrections other than the lens-based distortions.

One or more external sensors 147 (e.g., digital still cameras, video cameras, photodetectors, etc.) detects misalignments and uses software to populate a correction table with correction factors that were deduced from geometric considerations. If the display system already uses some kind of general purpose computer to generate its data, calibration system 140 can be integrated into that system or a separate system as shown. Sensor 147 typically directly captures light emitted by the display system. Alternately, a simple scattering target (e.g., small white surface) or mirror can be used, with a camera mounted such that it can collect light scattered from the target. In other examples, pre-determined test patterns can be displayed using the display, and subsequently characterized to determine system imperfections. This operation can be performed for all elements of the display at the same time, or it can be performed piecemeal, e.g., characterizing only one or more portions of the display at a time. The sensor is linked to the relevant computer system, e.g., through a digitizer or frame grabber. The auto-calibration algorithm can run on the computer system, generating the correction table for later use. During normal use of the display (i.e., times other than calibration) the sensor(s) can be removed, or the sensors can be integrated into an unobtrusive location within the display system.

In some embodiments, the auto-calibration routine is essentially a process of searching for a set of parameters that characterize each display element. Typically, this is done one display element at a time, but can be done in parallel. The sensor is positioned to collect light emitted by the display. For fast robust searching, the location of the sensor's aperture should be given to the algorithm. Running the routine for a single sensor position provides first-order correction information; running the routine from a number of sensor positions provides higher-order correction information. Once a sensor is in place, the algorithm then proceeds as follows. For a given element and/or display color, the algorithm first guesses which test data pattern (sent to the display modulator) will cause light to be emitted from that element to the sensor. The sensor is then read and normalized (e.g., divide the sensor reading by the fraction of total dynamic range represented by the present test data pattern). This normalized value is recorded for subsequent comparisons. When the searching routine finds the test data pattern that generates the optimal light, it stores this information. Once all display elements have been evaluated in this way, a correction table is derived from the knowledge of the optimal test patterns. The following pseudo-code illustrates the high-level routine:

for each of N sensor positions:

input xyz position of sensor
for each display element and primary color:

while level not > 0:

guess initial data pattern to emit light to sensor
note level (normalized sensor reading)

while optimal not yet found

dither data pattern

store optimal pattern information

derive correction table from stored information of optimal patterns

The “guess initial data” routine can use one or more different approaches. Applicable approaches include: geometric calculation based on an ideal display element, adjustments based on simulation of ideal display element, prediction based on empirical information from neighboring display elements, binary search. The “dither data pattern” routine can be an expanding-square type of search (if applicable) or more sophisticated. In general, any search pattern can be employed. To derive correction table data from the set of optimal patterns, the geometry of the display is combined with sensor position. This step is typically specific to the particular display. For example, the initial guess can be determined using a binary search of half-planes (x, y) to chose quadrant, then iterate within the optimal quadrant. In general, auto-calibration involves the application of different corrections to a pattern that is designed for a particular sensor response (e.g., brightness level from a particular display element) until that response is optimized. This set of corrections can therefore be used during general image generation.

More sensor positions can produce more refined, higher-order information for the correction table. For example, to measure distortions that might be produced by the optics of a display, the sensor can be located in three or more positions. Because distortions are generally non-symmetric, it is useful that the sensor position includes a variety of x and y values. The auto-calibration routine is typically performed in a dark space, to allow the sensor to see only light emitted by the display system. To improve sensor signal-to-noise ratio, the sensor can be covered with a color filter to favorably pass light emitted by the display. Another method for improving signal detection is to first measure a baseline level by setting the display to complete darkness, and using the baseline to subtract from sensor reading during the auto-calibration routine. Numerous variations on these basic techniques will be known to those skilled in the art.

Those having ordinary skill in the art will readily recognize that a variety of different types of optical components and materials can be used in place of the components and materials discussed above. Moreover, the description of the invention set forth herein is illustrative and is not intended to limit the scope of the invention as set forth in the following claims. Variations and modifications of the embodiments disclosed herein may be made based on the description set forth herein, without departing from the scope and spirit of the invention as set forth in the following claims.

What is claimed is:

1. An apparatus comprising:
at least one emissive display device;
a computer coupled to the at least one emissive display device and programmed to control delivery of autostereoscopic image data to the at least one emissive display device; and
a lens array coupled to the at least one emissive display device.

2. The apparatus of claim 1 wherein the at least one emissive display further comprises a first display region and a second display region; wherein the computer coupled to the at least one emissive display device is further programmed to control delivery of first autostereoscopic image data to first display region and second autostereoscopic image data to the second display region.

3. The apparatus of claim 2 wherein the lens array further comprises a plurality of lenslets, wherein at least one of the plurality of lenslets comprises a first lens corresponding to the first display region and a second lens corresponding to the second display region.

4. The apparatus of claim 1 wherein the lens array further comprises a plurality of lenslets, wherein at least one of the plurality of lenslets further comprises a bi-convex lens in optical communication with a plano-convex lens.

5. The apparatus of claim 1 wherein the at least one emissive display devices further comprises one or more of:
an electroluminescent display, a field emission displays, a plasma display, a vacuum fluorescent displays, a carbon-nanotube displays, a polymeric displays, or an organic light emitting diode display.

6. The apparatus of claim 1 wherein the at least one emissive display device further comprises a plurality of emissive display devices aligned with the lens array.

7. The apparatus of claim 1 wherein the computer further comprises a plurality of computers, and wherein a first one of the plurality of computers is further programmed to control delivery of first autostereoscopic image data to a first display region and wherein a second one of the plurality of computers is further programmed to control delivery of second autostereoscopic image data to a second display region.

8. The apparatus of claim 1 further comprising an array of light pipes coupled between the at least one emissive display device and the lens array.

9. The apparatus of claim 8 wherein the array of light pipes further comprises one or more of: an optical fiber bundle or an optical fiber taper.

10. The apparatus of claim 1 wherein the lens array is coupled to the at least one emissive display device using an index matching material.

11. The apparatus of claim 1 further comprising a mask array coupled to the lens array.

12. The apparatus of claim 1 wherein the autostereoscopic image data comprises hogel data.

13. The apparatus of claim 1 wherein the computer coupled to the at least one emissive display device is further programmed to render the autostereoscopic image data using one or more of: ray tracing, ray casting, lightfield rendering, or scanline rendering.

14. The apparatus of claim 1 further comprising:
at least one sensor positioned with respect to the lens array to detect light emitted from the at least one emissive display device, wherein the at least one sensor is coupled to one or more of the computer or a calibration computer system; the one or more of the computer or the calibration computer system executing calibration software using data from the at least one sensor.

15. The apparatus of claim 14 wherein the calibration software is further configured to generate a correction table based on the data from the at least one sensor.

16. The apparatus of claim 15 wherein the computer coupled to the at least one emissive display device is further programmed to render the autostereoscopic image data using data stored in the correction table.

17. The apparatus of claim 14 wherein the at least one sensor further comprises a plurality of sensors, and wherein the one or more of the computer or the calibration computer system executes calibration software using data from the plurality of sensors.

18. The apparatus of claim 14 wherein the calibration software is further configured to perform one or more of:
guess which test data pattern of a plurality of test patterns will generate the data from the at least one sensor when the test data pattern is displayed on the at least one emissive display device;
normalize the data from the at least one sensor;
record the data from the at least one sensor; and
determine which test data pattern generates an optimal signal when the test data pattern is displayed on the at least one emissive display device.

19. The apparatus of claim 1 further comprising one or more of a lens and a mirror configured to transmit light from the at least one emissive display device to the lens array.
